(19) United States
(12) Patent Application Publication
(10) Pub. No.: US 2007/0070070 A1
(43) Pub. Date: Mar. 29, 2007

(54) Method for cache-optimized processing of a digital image data set

(76) Inventor: Matthias John, Nurnberg (DE)

Correspondence Address: SCHIFF HARDIN, LLP;PATENT DEPARTMENT, 6600 SEARS TOWER, CHICAGO, IL, 60606-6473, US

(21) Appl. No.: 11/528,195

(22) Filed: Sep. 27, 2006

(30) Foreign Application Priority Data
Sep. 27, 2005 (DE) 10 2005 045 812.2

(51) Int. Cl. G06T 15/20

(52) U.S. Cl. 345/427

(57) ABSTRACT

An image proceseing algorithm is provided in the context of a cache-optimized optimization of an image data set to access at least one part of the pixels of the image data set in accordance with its image coordinates in an acces order determined by a space-filling curve.

### BACKGROUND

The invention concerns a method for cache-optimized processing of a digital image data set, particulary for application in the framework of a medical imaging system.

In the course of digital medical imaging methods (e.g., computer tomography), extensive digital image data sets are processed with electronic image processing. Such processing steps comprise the application of color, contrast or smoothing filters, coordinate transformations such as translation, rotation, scaling or mirroring, etc.

These processing steps are typically implemented using numerical algorithms that are implemented on computer systems with a conventional microprocessor architecture. In light of the large data sets that are typically manipulated in the processing of medical image data sets, these algorithms often run comparably slowly on conventional computer systems and sometimes take up a significant portion of the total run time of imaging applications. This can in turn lead to a noticeable impairment of the workflows in the course of which these applications are used. In a pracical implementation, the efficiency of the medical assessment of a digital x-ray image or CT image data set can suffer significanty from this when, in each image processing step of the image data set to be assessed, the system must wait several minutes for a refresh of the image on the screen as a result of the run time of one or more image processing algorithms.

Modem computer systems normally exhibit a comparably fast arithmetic data processing, however, only slow storage access in comparison to this. Under given boundary conditions, the slow storage access acts as a “bottleneck” that significantly limits the execution speed of a program executed on the computer system. This limitation concerns, to a particular degree, image processing algorithms, especially as a particularly high data throughout and, hereby in turn, a comparably intensive storage access are involved in these processes with the arithmetic computation capacity.

To accelerate the work speed, modem computer systems normally comprise an intermediate storage designated as a “cache”, or even a hierarchy of such caches. A cache is a memory with a comparably small storage volume that allows a significantly faster data access than the main memory and in which data that are currently required for a program workflow can be temporarily stored for a fast access.

The division of labor of cache and main memory can conventionally not be directly influenced by the programmer of application software. Rather, only a standardized access form to the memory content is provided in the framework of prevalent software development environments. During the execution of application sofware, the cache administration is accordingly not directly effected by the application software but rather is effected by internal structures of the computer system. Whether data content for an application software is obtained from the cache or directly from the main memory thereby depends on the current storage content of the cache. When a data request is made by the microprocessor, it is initially checked whether the requested data are present in the cache. When not, a date block comprising these data is typically loaded into the cache.

A data query that can be handled from the cache is designated as a cache hit. A data query for which, for lack of corresponding data in the cache, the main memory must be accessed is, by contrast, designated as a cache miss. In a conventional computer system, a cache miss claims more time by a factor of up to 50 than a cache hit. The optimization of the cache content in the program execution, and therewith the reduction of the number of the cache misses, thus holds a significant improvement potential given the implementation of application software, particularly in the field of electronic image processing.

A particularly high rate of cache misses is typically generated given affine coordinate transformations of images such as rotation, mirrorings, translations, or scalings, which is why such transformations are comparably time-intensive.

An optmization of the cache efficiency for image processing processes has previously been attempted, on the one hand, via development of special hardware configurations with a complex cache architecture or special cache access functions. However, this entails the usage of non-standard hardware and herewith in turn inevitably high costs.

On the other hand, special layouts for the storage of image data have sometimes been proposed that deviate from the prevalent image date formats. However, the usage of such storage layouts entails a conversion of the image data to be processed into the desired storage layout before the actual image processing step as well as a reconversion of the image after occurred processing. Due to this conversion step, the efficiency gain that can be achieved via a special storage layout is at least partially compensated again. The efficiency of such a storage layout additionally strongly depends on the algorithm with which the layout is used. In other words, various algorithms normally require various adapted storage layouts. A usage of adapted storage layouts thus makes the combination capability of various image processing algorithms more difficult.

A layout-based method for a data transformation is described in N. Park, et al., “Analysis of Memory Hierarchy Performance of Block Data Layout” in Proceedings of the ICCP 2002, IEEE, 2002, in which method a matrix is divided up into small data blocks, whereby the date elements comprised in one block are mapped to an associated memory range. The blocks are thereby arranged in the memory in accordance with various space-filling curves.

As an alternative to this, attempts have been made to achieve a cache-optimized implementation of image processing algorithms in which the access order of the algorithm to the image data is changed via an exchange of processing loops (loops) or block-oriented processing (loop blocking). In the former case, inner and outer loops of the algorithm are exchanged as needed, which, however, is only possible at all in a limited number of image processing algorithms. In the latter case, the image data of the image data set to be processed are read in and processed in the form of coordinate blocks (and not line-by-line, as is typical). Block-oriented processing is, however, only effective when the block size is adapted to the size of the cache and in particular does not exceed this. This is disadvantageous with regard to the compatibility of application software, especially as the cache size is different from computer system to computer system.

### SUMMARY

The invention is based on the object of providing an effective method for processing an image date set that is compatible with, and can be used with, simple mechanisms (hardware and software). The method particularly ensures a fast workflow of image processing algorithms, particularly those of affine coordinate transformations, on prevalent computer systems. Various embodiments of the invention are described below.

The object is inventively achieved via a method for cache-optimized processing of an image date set, comprising: providing an image data set comprising pixels arranged along multidimensional image coordinates; and executing an image processing algorithm in which at least one part of the pixels of the image date set is accessed in accordance with its image coordinates in an access order determined by a space-filling curve.

Accordingly, in the course of the execution of an image processing algorithm the method provides accessing at least one part of the pixels of an image data set to be processed with regard to its image coordinates in an access order determined by a space-filling curve.

What is to be understood as an image data set (subsequently “image” for short) hereby is a file that comprises a field (array) of image points (pixels). A color or brightness value as well as an n-dimensional (n=2, 3, . . . ) set of (image) coordinates that identify the position of each pixel relative to the other pixels is associated with each pixel.

The order in which the pixels of the image data set are originally stored in the main memory is designated as a storage order.

A sequence of mathematical instructions for modification of the pixels (in particular, a coordinate transformation, e.g., a translation, rotation, scaling or mirroring) is designated as an image processing algorithm (or “algorithm” for short). The designation “algorithm” is also used for individual components of a superordinate algorithm herein.

A formulation of an algorithm in instruction, suitable for a computer (particularly in the form of a programming language, a flow diagram, etc.) is designated as an implementation of an algorithm.

The term “space-filling curve” is used in the sense of the mathematical definition of this term, which is generally a steady, contiguous curve that enables a mathematical mapping of a one-dimensional real space to a multidimensional real space and thereby completely covers the multidimensional real space. Moreover, with the term “space-filling curve”, a discretization of this real mapping is designated that maps a finite number of successive points (here provided by the access order) to an arbitrarily fine discretization of a multidimensional cubold (here provided by the image or partial image), whereby each point of the discretization of the cuboid (or, respectively, image or partial image) is run through once, or at least once. Such space-filling curves and their discretizations are known and described, for example, in H. Sagan, “Space-Filling Curves”, Springer Verlag, 1994.

The invention proceeds from the realization that, on the one hand, the pixels of an image data set are normally stored in a linear storage order, i.e., successively one after another in the line direction (x-direction), line for line, as well as (in the case of 3D data) xy-plane for xy-plane etc, and that due to this storage order, pixels that are closely adjacent in the y- or z-direction are stored at comparably far-removed positions in the main memory.

Image data are furthermore typically accepted into the cache in blocks in a linear storage order, which (according to this realization) leads to the situation that, although the line neighbors of a requested pixel are present in the cache with comparably high probability, those pixels that are adjacent to this pixel in the y-direction or z-direction are not. According to this realization, this in turn leads to the situation that conventionally-implemented algorithms then incur a particularly high number of cache misses when they do not operate in the line direction but rather operate along the columns (y-direction) or, if applicable, stocks (z-direction) of the image.

In this case, the required information must be collected “bit by bit” from remote positions of the main memory. According to this realization, the cache administration of a conventional computer system in this case for the most part consumes unused power, i.e., fills the cache with image data that, for the most part, are not processed or are only processed by the algorithm at a later point in time.

Starting from the realizations described above, according to various embodiments of the invention, pixels are imported clustered according to the measure of their neighborhood relationship in the coordinate system of the image. In other words, pixels that are closely adjacent in the image should also be closely adjacent with regard to their position in the access order. This property of the access order is subsequently designated as a locality criterion.

Under consideration of the locality criterion, pixels are particularly frequently accessed whose line neighbors have already been imported shortly beforehand. According to this realization, such pixels are located in the cache with very high probability. An algorithm whose access order is aligned according to the locality criterion therefore generates only a few cache misses and thus operates very effectively. According to this realization, the locality criterion is now satisfied to a high degree in a simple manner via the access to the pixels along a space-filling curve.

The method can thereby be advantageously used in all computer systems that possess a cache and exhibit a cache administration that always loads the date stored in the main memory into the cache in blocks in successive storage order. This requirement is satisfied in most modem computer systems, such that the method can be compatibly used in standard computer systems. The application of the method requires no knowledge of the cache size; this is particularly so as space-filling curves are normally formulated or can be formulated in the form of recursive construction rules. The method is rather flexible and can be used without the requirement of an individual adaptation with caches of different size or a hierarchy of a plurality of caches.

With regard to the compatibility of the method, it is finally advantageous that the method does not directly influence the cache administration, particularly requiring no special access mechanism to the cache. Rather, the method merely creates advantageous boundary conditions under which a conventional cache administration already operates particularly effectively, in that, according to various embodiments of the invention, the image processing algorithm is fashioned to directly access the image data stored in the memory according to the pattern of a space-filling curve; this contrasts with layout-based methods, since the layout generation (and the runtime losses connected with this) are also omitted.

With regard to the areas that can be covered, a specific type of a space-filling curve frequently exhibits an established structure, for example, the structure of a square, a rectangle with established side ratio, etc. in particular, when the structure of the space-filling curve coincides with the image format, it is preferably provided to import all pixels along a single space-filling curve.

Particularly for application cases in which the image format of the image to be processed does not coincide with the structure of the space-filling curve, it has alternatively proven to be particularly advantageous to initially partition the image into a plurality of sub-images and to subsequently access the pixels of at least one of these sub-images along a space-filling curve. The pixels of the other sub-images are either conventionally processed or preferably processed along their own space-filling curve.

In order to be able to utilize the structure of the space-filling curve particularly well, given the division of the sub-images, consequently, in order to be able to at least significantly cover the entire image with optimally few (respectively limited to one sub-image) space-filling curves, it is provided that these sub-images also overlap, i.e., can comprise common pixels. Such common pixels are thereby preferably accessed only once. Given each further count (i.e., each further occurrence) in the access order, these pixels are simply skipped over.

In a preferred embodiment of the method, the determination of the access order ensues on the basis of a self-similar structure, space-filling curve; the locality criterion described above is satisfied particularly well given such curves. A curve is designated as self-similar when it exhibits a continuously-similar structure at different size scales. Self-similar space-filling curves that are known as mathematical phenomena are normally recursively generated via stringing together a repeating sequence in identical, rotated or mirrored form and can be arbitrarily expanded in this manner in all directions of the coordinate system taken up by the pixels. In particular, what is known as the Hilbert curve or what is known as the Peano curve are used as self-similar space-filling curves for the method.

The method can be particularly advantageously used on an affine transformation of image data, i.e., a translation, rotation, mirroring, scaling (i.e., enlarging or shrinking) or shearing of the image data or an arbitrary linear combination of the transformation routines cited above.

The subject matter of the invention is also a computer program product, in particular as a component of the application software of an imaging system, that is fashioned to implement the method described above.

### DESCRIPTION OF THE DRAWINGS

Exemplary embodiments of the invention are subsequently explained in detail using the following drawings.

FIG. 1 through 4 are pictorial diagrams illustrating an access order (determined using the Hilbert curve in its first through fourth recursion levels) for importation of an image data set with 2×2, 4×4, 8×8 or, respectively, 16×16 pixels;

FIG. 5 through 7 are pictorial diagrams illustrating an access order (determined using the Hilbert curve in its first through third recursion levels) for importation of an image data set with 3×3, 9×9 or, respectively, 27×27 pixels;

FIG. 8 is a pictorial diagram illustrating an access order for importation of an image data set comprising 17×17 pixels in two sub-images, whereby the access order with regard to the first sub-image is determined using the Hilbert curve; and

FIG. 9 is a pictorial diagram illustrating an access order for importation of an image data set comprising 19×16 pixels in five sub-images, whereby the access order with regard to all five sub-images is determined using the Hilbert curve.

Variables corresponding to one another are provided with the same reference characters in the Figures.

### DETAILED DESCRIPTION OF THE PREFERRED EMBODIMENTS

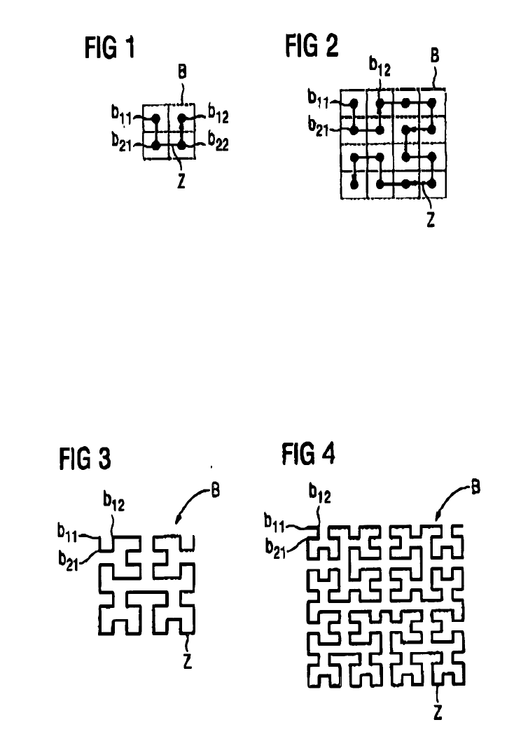

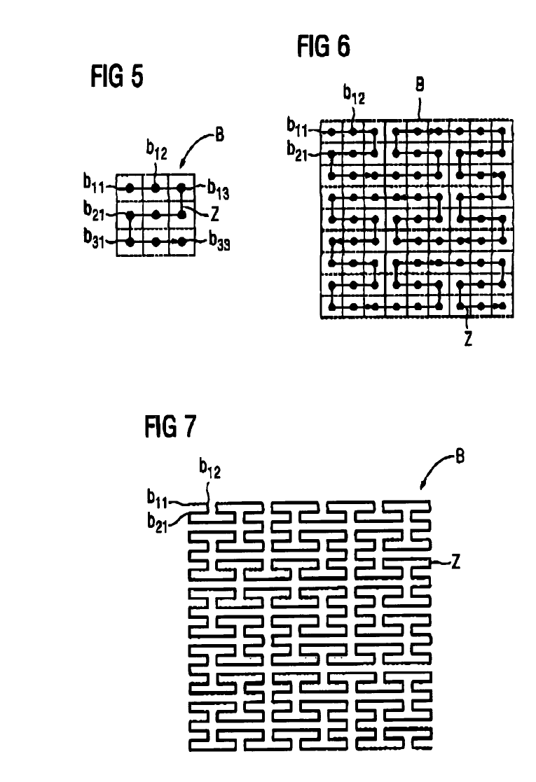

FIG. 1 through 9 respectively show in schematic representation a two-dimensional image data set (or image B for short). The image B generally comprises a number of N×M (N, M=2, 3, . . . ) pixels bᵢⱼ. Each pixel bᵢⱼ comprises a color or brightness value. Furthermore, a set of coordinates I (i=1, 2, . . . , N) and j (j=1, 2, . . . , M) that designate the position of each pixel bᵢⱼ in the image B is associated with each pixel bᵢⱼ. The pixels bᵢⱼ are arranged in the form of an orthogonal matrix in the image B. As a line index the coordinate I differentiates pixels bᵢⱼ within a column j. As a column index the coordinate j differentiates pixels bᵢⱼ within a line i.

Furthermore, an access order Z via which an image processing algorithm accesses the pixels bᵢⱼ in the course of various embodiments of the inventive method is represented in FIG. 1 through 7 in the form of a line connecting the pixels bᵢⱼ.

For reasons of clarity, FIGS. 3 and 4 as well as FIG. 7 are shown simplified in that in these the pixels bᵢⱼ are indicated merely by the vertices as well as the starting point and end point of the access order Z.

In FIG. 1 through 4 the access order Z is determined by what is known as the Hilbert curve that, in the course of FIG. 1 through 4, is shown in successive recursion levels adapted to a different size of the respective image B. FIG. 1 shows the basic shape/form of the Hilbert curve (also designated as a generator). From the representation, it can be recognized that the basic shape of the Hilbert curve comprises four fields (or quadrants) arranged in a 2×2 matrix that are processed in a U-shaped progress direction. At the first recursion level according to FIG. 1, each field comprises only a single pixel bᵢⱼ such that the image B containing 2×2 pixels bᵢⱼ is processed in the access order Z=b₁₁, b₂₁, b₂₂, b₁₂.

As the sequence of FIG. 1 through 4 shows, the access order Z determined by the Hilbert curve can be arbitrarily recursively expanded. At the transition from an initial level to the next-higher recursion level, the coordinate space spanned by the pixels bᵢⱼ to be sampled is doubled in the direction of both coordinates i and j, whereby the initial level is adapted as a first quadrant of the enlarged coordinate space. For the remaining quadrants the initial level is supplemented in a rotated or mirrored form, such that the access order Z expanded in such a manner always passes through all pixels bᵢⱼ of the enlarged coordinate space exactly once, and such that the access order Z successively processes the quadrants of the enlarged coordinate space in turn along a U-shaped progress direction (that is self-similar relative to the basic shape of the Hilbert curve).

The access order Z determined by the Hilbert curve includes 4×4 pixels bᵢⱼ in the second recursion level according to FIG. 2, 8×8 pixels bᵢⱼ in the third recursion level (FIG. 3) and 16×16 pixels bᵢⱼ in the fourth recursion level (FIG. 4).

FIG. 5 through 7 show an access order Z based on what is known as the Peano curve in different recursion levels. The Peano curve, like the Hilbert curve, is a self-similar, space-fitting curve that can be recursively, arbitrarily expanded analogous to the procedure described in the preceding.

FIG. 5 in turn shows the basic shape (or the generator) of the Peano curve that comprises nine fields arranged in a 3×3 matrix and that are processed along an S-shaped progress direction.

Both the Hilbert curve and the Peano curve can be expanded to higher-dimensional coordinate spaces without loss of their mathematical properties. The higher-dimensional variants of the Hilbert or, respectively. Peano curve are used as needed for determination of an access order for image date of N-dimensional images (N=3, 4, etc.).

The method variants described in the preceding, in which all pixels bᵢⱼ of the image B are imported along a single space-filling curve, can particularly be advantageously used when the image B is not too large and, with regard to its image format, coincides with the structure of the underlying space-filling curve. The shape of the point pattern included by the space-filling curve in its k-th (k=1, 2, . . . ) recursion level is hereby designated as a structure of the space-filling curve. As is to be learned from FIG. 1 through 4, the Hilbert curve accordingly has a structure of 2^{k}×2^{k} pixels bᵢⱼ; as is to be learned from FIG. 5 through 7, the Peano curve has a structure of 3^{k}×3^{k} pixels bᵢⱼ.

In contrast to this, if the image B comprise very many pixels bᵢⱼ or if the image form does not correspond to the structure of the Hilbert curve or of the Peano curve, the image B is initially divided into a number of sub-images T₁ (j=2, 3, 4, . . . ), of which at least one is imported along the Hilbert curve or Peano curve.

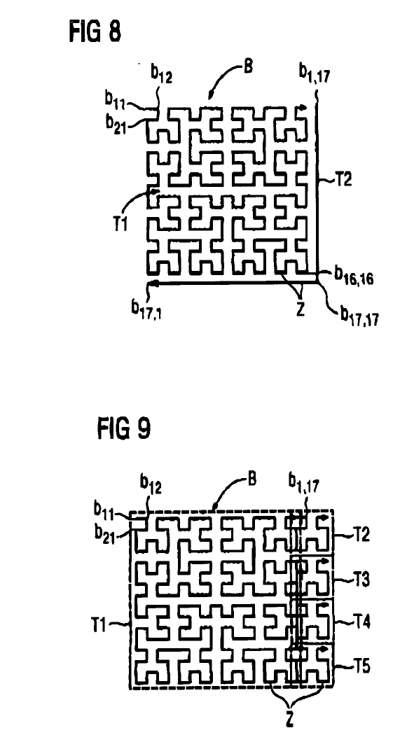

FIG. 8 exemplarily shows such a developed access order Z for importation of an image B with 17×17 pixels bᵢⱼ. The Image B is divided into a first sub-image T₁ and a second sub-image T₂. The sub-image T₁ thereby comprises the pixels b_{1,1} through b_{18,18} and is thus particularly selected such that it corresponds to the structure of the Hilbert curve in its fourth recursion level. The sub-image T₂ comprises the remaining pixel b_{1,17} through b_{17,17} as well as b_{17,16} through b,_{17,1}. The access order Z contains the pixels bᵢⱼ of the first sub-image T₁ corresponding in their order predetermined by FIG. 4. The pixels bᵢⱼ of the second sub-image T₂ are subsequently linearly imported in the column or, respectively, line direction.

FIG. 9 exemplarily shows an access order Z for importation of an image B with 19×16 pixels bᵢⱼ. The image B is hereby divided into respective quadratic sub-images T₁ through T₅, of which the sub-image T₁ again comprises the pixels b₁₁ through b_{16,16}. The remaining right border of the image B is covered by the sub-images T₂ through T₅ whereby each of these sub-images T₂ through T₆ overlaps with the sub-image T₁ in one pixel column. Within each of the sub-images T₁ through T₅ the respective pixels bᵢⱼ contained therein are accessed along a corresponding recursion level of the Hilbert curve. The pixels bᵢⱼ of the 16th image column that are contained twice in the access order Z are only accessed in the processing of the first sub-image T₁. In the processing of the sub-images T₂ through T₅, these pixels bᵢⱼ are skipped over.

In principle, it is also conceivable to determine the access order Z in various sub-images using different space-filling curves.

In order to economize at runtime for the calculation of the access order, in the framework of a computer program implemented according to various embodiments of the inventive method, the Hilbert curve and/or the Peano curve are advantageously predetermined as coordinate series in one or more recursion levels.

Alternatively, the access series can also be calculated during runtime via a recursive constructive method for the Hilbert curve or, respectively, the Peano curve. A suitable recursive construction method for the Hilbert curve is, for example, known from G. Breinhold, Ch. Schlerz, “Algorithm 781; generating Hilbert's space-filling curve by recursion”, ACM Trans. of Math. Software (TOMS), 23(2), 1998, p. 184-189.

### Experimental Comparison

The inventive method was tested using a simplified test program which, in the framework of an algorithm for an image rotation by 90° or, respectively, by 45°, divides the image data data set to be processed into sub-images respectively comprising 64×64 pixels and accesses the pixels of each sub-image in the order predetermined by the Hilbert curve (6th recursion level).

The test program (subsequently designated with “Hilbert” for short) was compared, on the one hand, with a first comparison program (subsequently designated as “Standard” for short) in which the rotation algorithm is implemented conventionally in that the pixels of the image are accessed line by line.

The test program was, on the other hand, compared with a second comparison program which accesses the pixels in the form of rectangular blocks given the execution of the rotation algorithm, however again accesses the pixels line-by-line within each block. This comparison program was tested with a block size of 16×16 (subsequently “block 16”) as well as 32×32 (subsequently “block 32”) pixels, optimized for the computer system used.

The test program as well as both comparison programs was tested on a computer system with a microprocessor architecture of the type Intel Pentium 4 CPU, 2 GHz with 1 GB RAM, 8 KB L1 cache and 512 KB L2 cache.

The test program as well as both comparison programs were coded in C++ and compiled wl the GNU C++ compiler (g++) at the optimization level −O.

The algorithms were tested on 2D images of various sizes (1024×1024, 2048×2048, etc.).

The results of the test series are listed in Table 1. From the table it is clear that the inventively implemented rotation algorithm (Hilbert) exhibits a significant runtime advantage for both rotations, both relative to the line-oriented rotation algorithm (standard) and relative to the block-oriented rotation algorithm (block 16/block 32); the advantage increasingly develops with increasing image size.

Given the comparison of the inventively-implemented rotation algorithm with the block-oriented rotation algorithm, the comparably good performance of the latter was only achieved via preceding optimization of the block size for the computer system used, while the inventive rotation algorithm requires no individual adaptation to the computer system.

TABLE 1

| | Image size | | | | |
|---|---|---|---|---|---|
| | 1024 × | 2048 × | 4096 × | 6144 × | 8192 × |
| Algorithm | 1024 | 2048 | 4096 | 6144 | 8192 |
| Implementation | Runtime (sec) | | | | |
| Rotation 90 | | | | | |
| Hilbert | 0.02 | 0.11 | 0.45 | 0.97 | 2.09 |
| Standard | 0.10 | 0.43 | 1.79 | 3.91 | 8.23 |
| Block 16 | 0.03 | 0.12 | 0.52 | 1.21 | 2.43 |
| Block 32 | 0.03 | 0.12 | 0.47 | 1.08 | 7.60 |
| Rotation 45 | | | | | |
| Hilbert | 0.02 | 0.09 | 0.45 | 0.91 | 2.00 |
| Standard | 0.02 | 0.09 | 1.26 | 2.83 | 5.69 |
| Block 16 | 0.02 | 0.11 | 0.48 | 1.04 | 2.12 |
| Block 32 | 0.03 | 0.11 | 0.45 | 0.92 | 3.65 |

Runtime comparison of an Inventively-Implemented rotation algorithm (Hilbert) with comparison programs (standard, block 16, block 32) on 2D images of different image sizes (1024 × 1024, . . .) for a 90° rotation as well as a 45° rotation

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming element. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for cache-optimized processing of an image date set, comprising:
providing an image data set comprising pixels arranged along multidimensional image coordinates; and
executing an image processing algorithm in which at least one part of the pixels of the image date set is accessed in accordance with its image coordinates in an access order determined by a space-filling curve.

2. The method according to claim 1, wherein the image processing algorithm is an affine image transformation.

3. The method according to claim 2, wherein the image processing algorithm is a rotation or a mirroring.

4. The method according to claim 1, further comprising:
utilizing a Hilbert curve or a Peano curve as determining the access order.

5. The method according claim 1, further comprising:
dividing the image data set into a plurality of sub-images, wherein pixels of at least one sub-image are accessed in accordance with its image coordinates in an access order determined by a space-filling curve.

6. The method according to claim 5, wherein:
at least two sub-images overlap one another; and
pixels contained multiple times in the access order are skipped over given the second and each additional count in the access order.

7. A computer program product comprising data contained thereon, that, when loaded onto a computer processor, performs:
providing an image data set comprising pixels arranged along multidimensional image coordinates; and
executing an image processing algorithm in which at least one part of the pixels of the image data set is accessed in accordance with its image coordinates in an access order determined by a space-filling curve.
